(19) United States
(12) Patent Application Publication
(10) Pub. No.: US 2011/0203212 A1
(43) Pub. Date: Aug. 25, 2011

(54) FACING ELEMENT AND METHOD OF FABRICATING THEREOF

(76) Inventors: Tyler Matys, Aurora (CA); Angelo Risi, Richmond Hill (CA)

(21) Appl. No.: 13/123,335

(22) PCT Filed: Oct. 8, 2009
(86) PCT No.: PCT/CA2009/001435

§ 371 Date: Apr. 8, 2011

Related U.S. Application Data
(60) Provisional application No. 61/103,667, filed on Oct. 8, 2008.

(51) Int. Cl. E04C 2/04; B29C 39/10

(52) U.S. Cl. 52/562; 264/274

(57) ABSTRACT

A facing element for at least partially covering a structure. The facing element has at least one pair of first and second rigid engagement connectors affixed to a rear surface of the facing element. Each of the first and second engagement connectors forms first and second apertures between the connectors and the rear surface of the facing element. The first and second apertures are coaxially located. The facing element also has at least one joining bar joining the first and second engagement connectors. The top portion of the facing element is hung to the structure by means of the first engagement connector. Contact of the bottom portion of the facing element with the structure is offset by the second engagement connector. A method for fabricating such a facing element is also disclosed.

### RELATED APPLICATIONS

This application is the U.S. National Phase under 35 U.S.C. §371 of International Application No. PCT/CA2009/001435, filed on Oct. 8, 2009, which in turn claims the benefit of U.S. Provisional Application No. 61/103,667, filed on Oct. 8, 2008, the disclosures of which Applications are incorporated by reference herein.

### FIELD OF THE INVENTION

The present invention generally relates to facing elements. More specifically, the present invention relates to a facing element for at least partially covering a structure, and a method of fabricating such an element.

### BACKGROUND OF THE INVENTION

The present invention relates to the combination of a wet cast concrete mold system, integrated connector or mounting system, and related process for wet casting relatively small and light concrete veneers used as a facing element or façade for small buildings, retaining walls, or other structures.

The purpose of the wet cast concrete veneer is to provide a more aesthetically pleasing facing for a structure as noted above. Currently, a number of manufacturers produce wet cast concrete veneers that simulate stone, wood, or other materials by pouring wet concrete into flexible molds. The molds, made of a durable but flexible material such as polyurethane, have been formed to create exact replicas of the relief and textures of the materials (stone, wood, etc.) they represent. The fluid nature of the wet concrete allows it to flow into the mold and take on the shape and texture of the mold. Currently, the veneers are manufactured with the textured face on one side (the exposed face) with a smooth back surface. Typically, the veneers are secured to a rigid (non flexible) structure with mortar or other adhesives (concrete or construction adhesive), using a steel lathe backing or other binding interface.

Different facing element or panel concepts are disclosed in the prior art.

In Patent CA 2,244,348 (by G.P. Industries—hereinafter referred to as the G.P. Patent), the panels have a positive shear key in the back that slides vertically into the face of the structural block behind (the method of production or description of how this shear key would be possible in production is not disclosed in the patent). As such, the panels are slid on top of one another and therefore bear only on one another and are not vertically supported at each block level, but rather, on top of the “stack” of panels. This approach has numerous drawbacks and limitations, which will be discussed later.

Japanese laid-open application JP 2000/064244 to GEOSTR CORP. discloses a rigid connection of the facing panel to the block. In this Japanese document standard screw/nuts are used to rigidly secure the panels, allowed in the rigid forms of rigid retaining walls such as reinforced concrete, sheet pile, etc. No mention is made of flexible segmental retaining walls. A non-rigid connection could also help facilitate installation of such panels.

Typically, when wet casting concrete into a form or mold, the concrete must be workable and flow easily into the mold. The “wet” or fluid nature of the concrete allows it to form to very detailed shapes, textures, and reliefs. As such, it is common practice to reproduce textures such as natural stone or wood to create manufactured versions of these materials in the form of a veneer or facing element. The molds are often flexible, but can be stiff, and generally made out of a polymer that is able to be poured over the actual material being reproduced, thereby duplicating the form and texture, then harden in this shape over a short period of time. A workable material such as wet concrete is then poured into the mold, which then cures over a period of around 12 hours, and is then removed.

While the production of these manufactured veneers is fairly commonplace, Canadian laid-open Patent application No. 2,547,415 entitled “Combination of a Structural Block and Facing Element attached Thereto” in the name of the same present inventors introduced the concept of a panel being supported, but not rigidly attached to a hanger element placed into the face of a structural block. The specific benefit of this “free floating” facing is the ability to construct non-rigid structures such as segmental retaining walls, which allow for settlement and frost movement without causing distress to the structure. This free floating connection also allows the panels to rotate about their mounting post, which provides the ability to create curving alignments in the wall. The integrated connector negates the need for adhesives or mortar, which simplifies installation and reduces installation time significantly.

As such, there still exists a need for a facing element for attachment to a structure which overcomes some of the problems found in the prior art, as well as a method for fabricating such an element.

### SUMMARY OF THE INVENTION

An object of the present invention is to provide a facing element for at least partially covering a structure which overcomes at least one of the above-identified deficiencies found in existing techniques.

Another object of the present invention is to provide a method for fabricating such a facing element.

According to the present invention, there is provided a facing element for at least partially covering a structure, the facing element comprising:
a top portion and a bottom portion;
at least one pair of first and second rigid engagement connectors made of plastic and affixed to a rear surface of the facing element, each of the first and second engagement connectors forming first and second apertures between said connectors and the rear surface of the facing element, said first and second apertures being coaxially located; and
at least one joining rod joining a top portion of the first and second engagement connectors, said top portion being offset from the facing element,
   wherein the top portion of the facing element is hung to said structure by means of the first engagement connector, and a contact of the bottom portion of the facing element with respect to the structure is offset by the second engagement connector.

According to the present invention, there is also provided a method of fabricating a facing element for at least partially covering a structure, the method comprising the steps of:
a) providing a mold comprising:
   a bottom wall, a front wall, a rear wall and opposite sidewalls forming a closed bottom enclosure with an open top; and
   at least one pair of opposite facing mounting slots, respectively positioned on a top portion of each of the opposite sidewalls;
b) providing at least one connector piece comprising:
   a pair of first and second rigid engagement connectors made of plastic; and
   at least one joining rod joining a top portion of the first and second engagement connectors, said at least one joining bar sized to extend and set into the at least one pair of opposite facing mounting slots;
c) inserting the at least one connector piece into the mounting slots of the mold through the at least one joining rod;
d) pouring a casting substance into the mold up to a level wherein each of the first and second engagement connectors forms first and second apertures between said connectors and a top surface of the poured casting substance, said first and second apertures being coaxially located, said at least one joining rod and the top portion of the first and second engagement connectors being offset from the poured casting substance;
e) curing the casting substance to form the facing element;
f) removing the casted facing element from the mold.

The present invention introduces an integrated connector system into the back of the panel during the wet casting process, thereby negating the need for mortar or adhesives and also creating a “free floating” connection that allows for minor movements of the structure without causing distress to the facing.

A non-restrictive description of a preferred embodiment of the invention will now be given with reference to the appended drawings.

### BRIEF DESCRIPTION OF THE DRAWINGS

FIG. 1 is a perspective view of engagement connectors for a facing element according to a preferred embodiment of the present invention;

FIG. 2 is a side view of the connectors shown in FIG. 1;

FIG. 3 is a top view of the connectors shown in FIG. 1;

FIG. 4 is a side cut view of the connectors shown in FIG. 1, partially immersed in concrete;

FIG. 5 is a perspective view of a mold according to a preferred embodiment of the present invention;

FIG. 5a is a detailed perspective view of a mounting slot of the mold shown in FIG. 5;

FIG. 6 is a top view of the mold shown in FIG. 5;

FIG. 6a is a detailed top view of a mounting slot of the mold shown in FIG. 6;

FIG. 7 is a side cut view of the mold shown in FIG. 5;

FIG. 7a is a detailed side view of a mounting slot of the mold shown in FIG. 7;

FIG. 8 is a front cut view of the mold shown in FIG. 5;

FIG. 8a is a detailed front cut view of a mounting slot of the mold shown in FIG. 8;

FIG. 9 is a perspective view of the mold shown in FIG. 5, with the connectors of FIG. 1 inserted into the mounting slots;

FIG. 9a is a detailed perspective view of the connector/mounting slot interface shown in FIG. 9;

FIG. 10 is a top view of the mold shown in FIG. 5, with the connectors of FIG. 1 inserted into the mounting slots, after pouring of a casting substance;

FIG. 10a is a detailed top view of a mounting slot of the mold shown in FIG. 10;

FIG. 11 is a side cut view of the mold shown in FIG. 5, with the connectors of FIG. 1 inserted into the mounting slots, after pouring of a casting substance;

FIG. 11a is a detailed side view of a mounting slot of the mold shown in FIG. 11;

FIG. 12 is a front cut view of the mold shown in FIG. 5, with the connectors of FIG. 1 inserted into the mounting slots, after pouring of a casting substance;

FIG. 12a is a detailed front cut view of a mounting slot of the mold shown in FIG. 12;

FIG. 13 is a perspective view of the mold and connectors according to a preferred embodiment of the present invention depicting concrete being poured to the top of the mold and partially submerging the connectors;

FIG. 14 is a perspective view of a facing element according to a preferred embodiment of the present invention after being extracted from the mold following curing of the casting substance;

FIG. 15 is a top and side view of a facing element according to a preferred embodiment of the present invention being mounted onto a segmental retaining wall block;

FIG. 16 is a top and side view of a facing element according to a preferred embodiment of the present invention being mounted onto a wood frame building;

FIG. 17 is a top view of a facing element according to a preferred embodiment of the present invention being mounted onto a segmental retaining wall block, as shown in FIG. 15, but shown with multiple blocks in a row in straight alignment; and

FIG. 18 is a top view of a facing element according to a preferred embodiment of the present invention being mounted onto a segmental retaining wall block, as shown in FIG. 15, but shown with multiple blocks in a row in curved alignment.

### DETAILED DESCRIPTION OF A PREFERRED EMBODIMENT

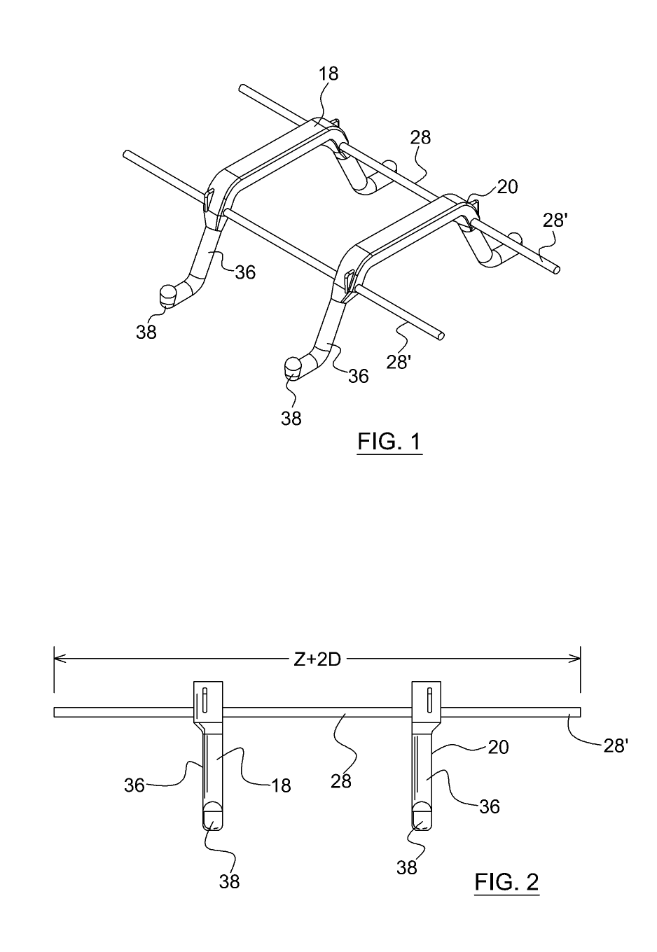

FIGS. 1 to 4 and 13 to 18 illustrate a facing element 10 and components thereof according to a first preferred embodiment of the present invention.

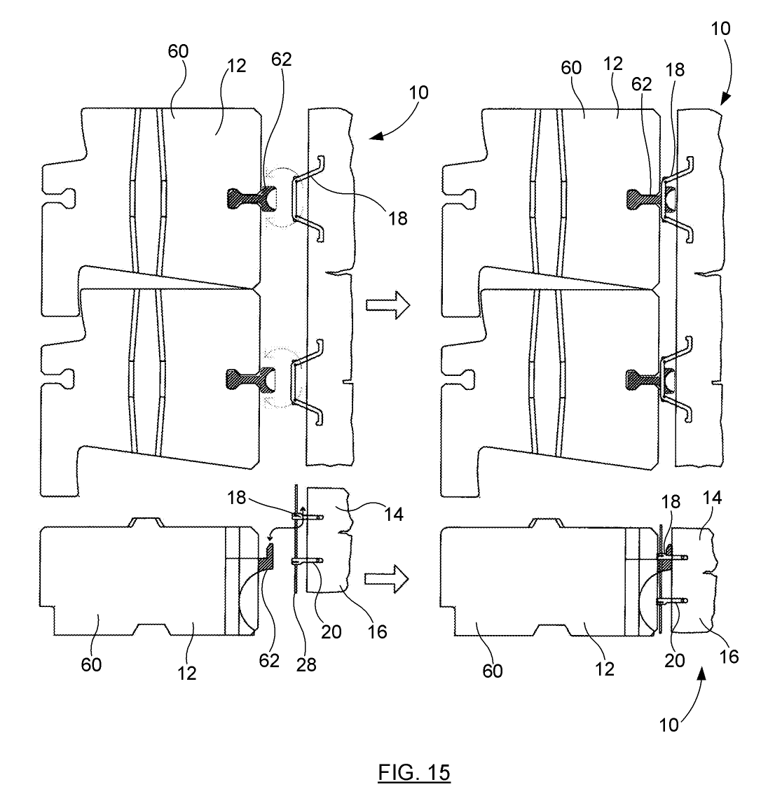

The facing element 10 is to be used for at least partially covering a structure 12, as shown in FIGS. 15 to 18. As better shown in FIG. 13, the facing element 10 comprises a top portion 14 and a bottom portion 16. The facing element also comprises at least one pair of first and second rigid engagement connectors 18,20 affixed to a rear surface 22 of the facing element 10. Each of the first and second engagement connectors 18,20 forms first and second apertures 24,26 between the connectors 18,20 and the rear surface 22 of the facing element 10. The first and second apertures 24,26 are coaxially located.

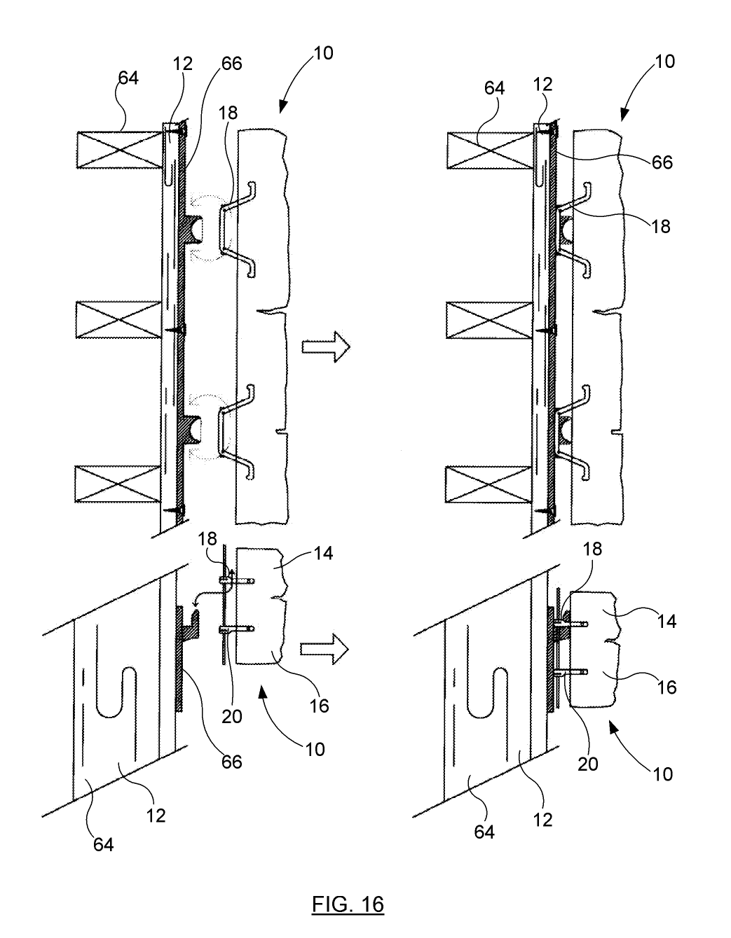

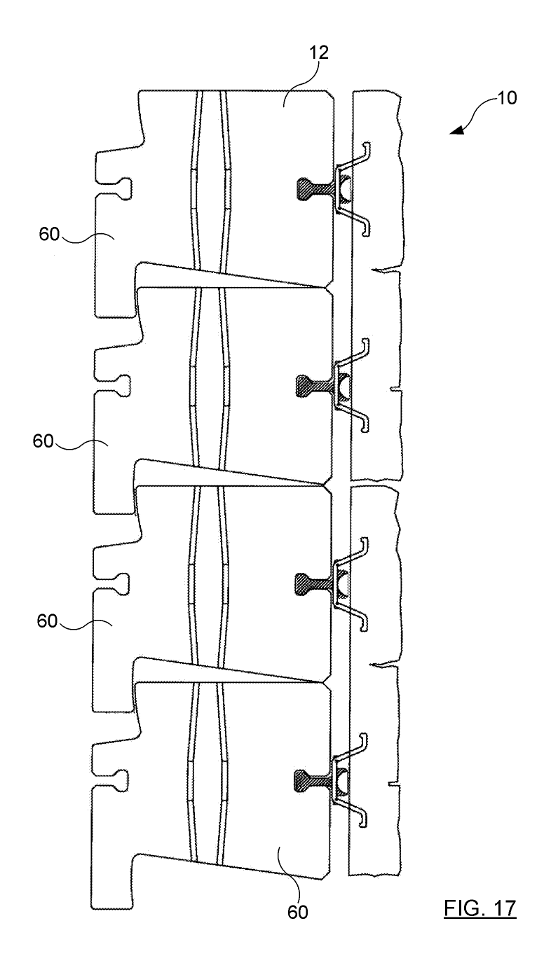

As better shown in FIGS. 1 to 3, the facing element 10 also comprises at least one joining bar 28 joining the first and second engagement connectors 18,20. As better shown in FIGS. 15 and 16, the top portion 14 of the facing element 10 is hung to the structure 12 by means of the first engagement connector 18, and a contact of the bottom portion 16 of the facing element 10 with respect to the structure 12 is offset by the second engagement connector 20.

Preferably, as shown in FIGS. 1 to 3, the facing element comprises two parallel joining bars 28 joining the first and second engagement connectors 18,20.

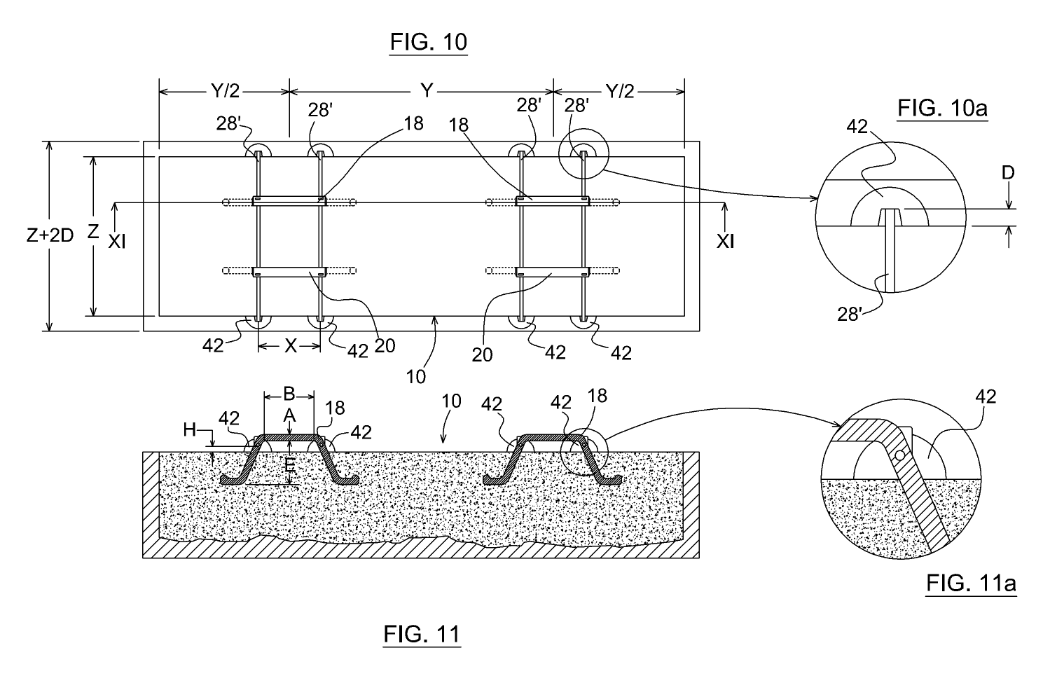

Preferably, the first and second engagement connectors 18,20 are substantially U-shaped. Preferably, as better shown in FIGS. 10 to 12, the first and second engagement connectors 18,20 are affixed to the facing element 10 by molding the facing element 10 around the first and second engagement connectors.

Preferably, the facing element is made of a pre-cast concrete, but the facing element can be made of any appropriate type of casting substance.

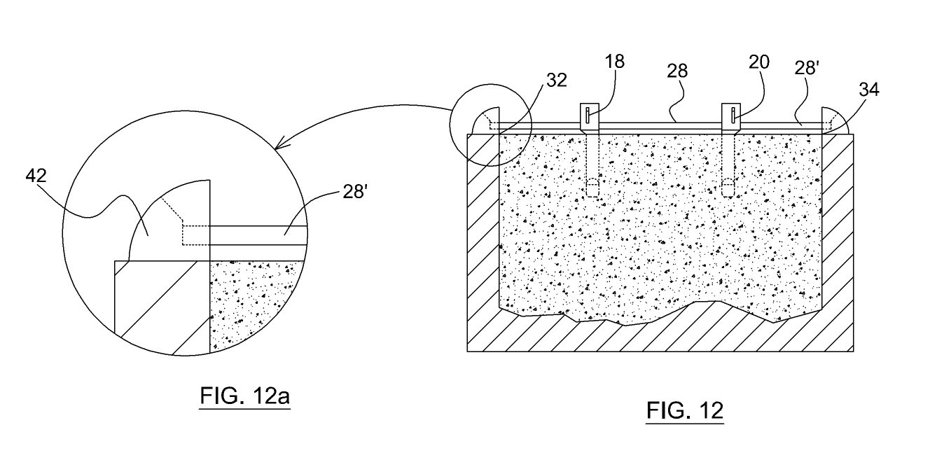

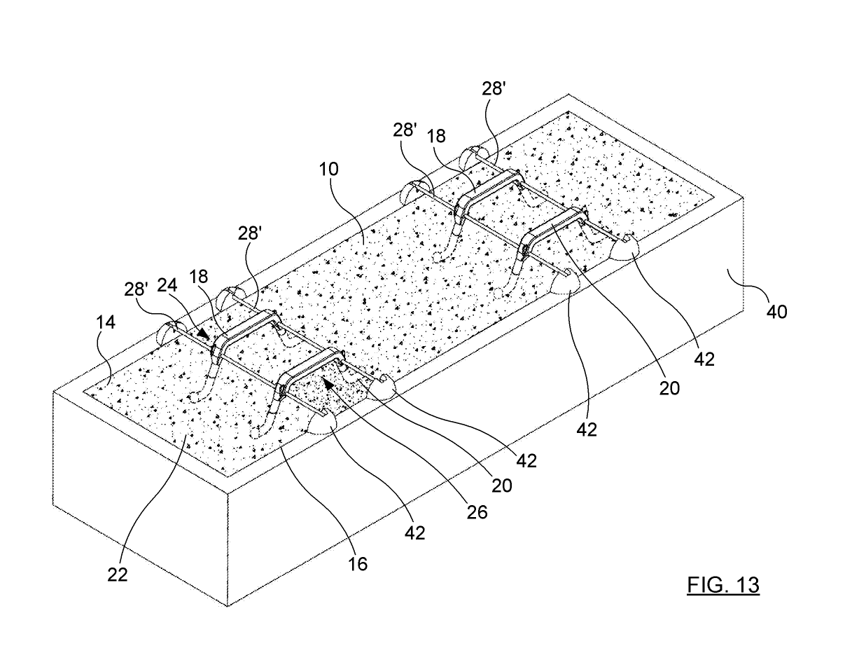

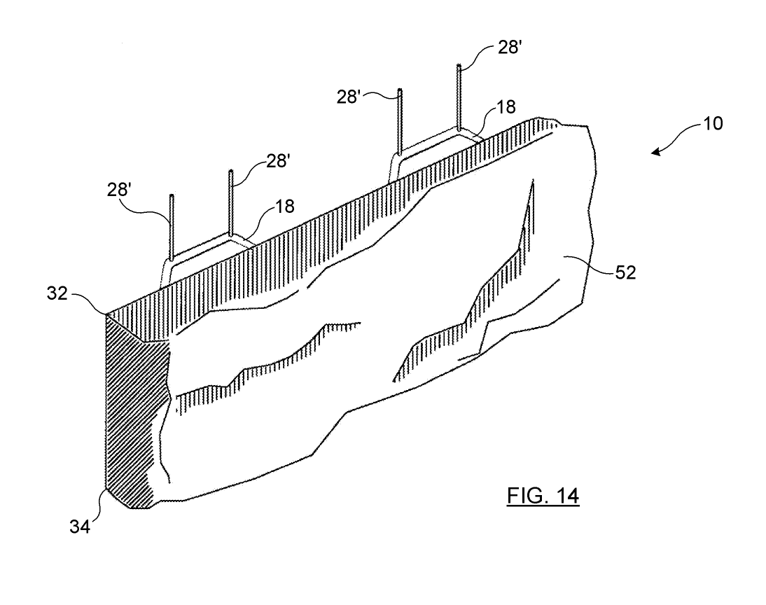

As better shown in FIG. 12 or 14, the at least one joining bar 28 joining the first and second engagement connectors 18,20 extends beyond two opposite sides 32,34 of the rear surface 22 of the facing element 10.

Preferably, as better shown in FIGS. 1 to 4, each of the first and second engagement connectors 18,20 comprises a pair of anchorage legs 36 set in the facing element 10. The legs 36 are splayed at an angle with respect to the rear surface 22 of the facing element 10.

Preferably, each anchorage leg 36 comprises a bulb 38 at an extremity thereof.

In accordance with another preferred embodiment of the present invention, the second engagement connector 20 can be positioned to fit on a secondary securing hanger extending from the structure 10 when the top portion 14 of the facing element 10 is hung to the structure 12.

The facing element 10 according to the present invention can be used in conjunction with the system disclosed in the Risi/Matys Patent Application CA 2,547,415 “Combination of a Structural Block and Facing Element attached Thereto”, which introduced the concept of a panel being supported, but not rigidly attached to a hanger element placed into the face of a structural block.

The specially designed connector system is set into the wet concrete immediately following the pour in order to embed it into the veneer or facing element, thereby permanently securing it once the concrete has cured. The connector system and wet cast mold are designed as compatible elements in order to “suspend” the connector apparatus over the wet concrete at a set distance.

The connector is formed of a dissimilar material such as a plastic/polymer, steel, or another suitable structural material, and is generally arranged in a “double U” configuration.

The exposed portion of the connector is used to mount the facing element or veneer to a male receptacle secured to the structure, known as a “hanger”.

In a preferred embodiment, the exposed portion is shaped as a “double loop” or “double U” to form a positive connection with the corresponding hanger fixed to the structure being faced. This allows the veneer panel or facing element to be vertically supported on the corresponding hanger and not on the panel below it. This is a fundamental difference from prior art represented in Canadian Patent CA 2,244,348.

The lower portion of the “double loop” connectors forms the anchoring legs 36, which provide the anchorage of the connectors 18,20 into the concrete. The anchoring legs 36 are designed to provide pullout capacity in the concrete in both horizontal and vertical directions. In a preferred embodiment, the anchoring legs 36 enter the concrete at an angle with respect to the vertical, to a specified depth (Refer to FIG. 4, Angle C).

Furthermore, significant research and testing has shown that it is critical that the connectors and the concrete must be compatible materials. Specifically, properties including water absorption, permeability, modulus of elasticity, coefficient of thermal expansion, chemical resistance, dimensional stability, and flexural modulus must be kept within specific allowable limits to ensure internal stresses due to changes in moisture, temperatures, as well as conditions within the concrete are accommodated.

When considering prior art systems, the integral connectors 18,20 and the “non fixed” free floating aspect of the present design is what separates it from anything in the past and provides significant advantages. Furthermore, as our proposed facing elements or veneer panels are individually supported at each hanger/block level, a panel does not rely on the stack of panels below it for vertical support, which is the case with the G.P. Patent. As such, differences in the height of the panel relative to the height of the block do not have a negative “cumulative” effect when stacking with our invention. For example, in the manufacturing of concrete products, certain allowable dimensional tolerances exist. Currently, the National Concrete Masonry Guidelines allow for a tolerance on the height of a block to be within +/−3 mm (⅛″). As the facing panel and the block are being produced on different machinery and at different times, it is almost inevitable that differences will exist between the height of the SRW (segmental retaining wall) of the block and the veneer panel (facing element or panel). Applying the G.P. Patent, these minor height differences will accumulate over the height of the wall, worsening with each successive course. If, for example, a negative difference of 2 mm exists between the height of the blocks (+2 mm) and the height of the panels (0 mm), after only 5 courses of block, the cumulative effect will be that the wall will be 10 mm higher than the stack of facing panels in front. This will leave a 10 mm gap at the top of the wall. In contrast, with the integral connector and hanger system being proposed, the facing element or panel according to the present invention will be corrected at each level, resulting in the minor differences in height being taken up at each course, which actually promote a major concept of this system, which is allow free movement within the matrix of veneer panels for settlement, frost action, etc.

As discussed, the preferred use of the invention is as a segmental retaining wall block system. A segmental retaining wall, by its nature, is considered a “flexible” structure. It is composed of blocks that are not rigidly fixed with mortar or adhesives. The “dry-stacked” blocks therefore allow for relative movement due to total or differential settlement, frost heave, etc., without leading to failure of the structure. As such, the facing element or panel and block system has been designed to be flexible by using a non-rigid “free floating” connection of the panel to the block.

In the present invention, contrary to what is disclosed in the prior art, the facing element or panel is vertically supported, but free to move up or side to side within set limits to work with flexible structures such as SRWs.

Contrary to what is disclosed in the G.P. Patent discussed hereinabove, the facing element or panel is simply supported only on the vertical post, not adjacent panels or blocks below it. The fundamental difference in the present concept is that the panel does not bear on panels or blocks below it for vertical support, and therefore, creates an expansion/movement joint between panels and avoids stresses between them. The G.P. Patent does not deal with any of the issues related to settlement or movement of these non-rigid structures. Also, the fact that the facing elements or panels are supported, yet movable, allows the panels to turn curves and other non- standard alignments and span more than one vertical course.

As discussed, a main feature of the present invention is to provide a simply supported, non-fixed (non-rigid) connection of the facing panel to a hanger system, contrary to what is disclosed in Japanese laid-open application JP 2000/064244 to GEOSTR CORP. In accordance with a preferred embodiment, engagement connectors 18,20 (which are set or fixed to the facing panel) are supported vertically by the hanger components, but are not fixed in one position either horizontally or vertically to the hangers. Rather, the engagement connectors are simply supported or rest on the hanger ledge, but are not secured or rigidly fixed. Depending on the relative dimensions of the loop/hanger components, a certain range of free motion between the fixed block (retaining wall or other structure comprised of the blocks) and the facing panel is allowed.

The free movement between the stable retaining wall (structural units) and the supported, but non-fixed (within a certain range) facing element provides the following benefits and significant advantages over prior art previously referenced in the patent. This type of connection can be achieved in a number of ways, such as a ball/joint connection, a loop/hanger connection (as shown in the preferred embodiment), or other positive type connections that allow a certain range of free motion, all of which are to be encompassed in this patent.

Benefits of the simply supported, non-fixed (non-ridgid) connection between facing panel and structural block include:

1. Allowing Movement of Facing Elements Against the Forces of Ice/Snow Expansion During Freezing Cycles. The facing element or panel is free to move outward or upward within a certain range. As the facing system is designed as a “free floating” panel, expansion joints (separation spaces) exist on all four sides of each panel relative to adjacent panels. In the event that ice, snow, or saturated soil becomes trapped within these joints or behind the facing panel (between the facing panel and the structural block), the possibility may exist that the water contained within this material may expand and contract with natural free/thaw cycles. The expansion of snow/ice or saturated soil (with high moisture content) trapped on the sides or behind the facing panels may create significant, potentially damaging, outward forces on the panel. If the panel is fixed, it will act to restrain or resist these forces, causing stress to the panel and potentially cracking the panel until the force of the ice/snow or frozen saturated material is released. In a preferred embodiment, the panel initially sits flush with the face of the block, the loop being at the back of the hanger. The hanger bearing surface is wider that the loop, and in the preferred embodiment, the bearing surface may be sloped back toward the structural block. As such, when the panel is “hung”, it will naturally slide down on the bearing surface of the hanger towards the face of the structural block and sit flush against it. In the event that ice/snow or other material is trapped between the structural block and the facing panel, or between adjacent facing panels, and an outward expansion force is generated during a freezing cycle, the panel is free to move outward, and the expansion force will be absorbed. Depending on where the force is acting relative to the non-fixed support point, the panel is also free to rotate about the connection point, which is another effective mechanism for releasing of expansion forces.

2. Allowing Movement of the Facing Elements During Wall Movement/Settlement. One of the main advantages of this facing element or panel system, discussed previously, is the “free floating” nature of the panels and connection system. That is, the panel does not bear directly on the structure block below it, nor does it bear on or against the adjacent panels. This “suspension” of the panel away from the structural system allows for natural movements/settlements of the structural system, common particularly to segmental retaining walls, without causing contact stresses on the panel. The amount of allowable movement or settlement of the system is limited to the expansion joint dimensions around the outside of each panel, before panels contact each other. However, in the extreme case that movements and settlements of the structure exceed the range allowed by the presence of the expansion joints between the panels, the non-rigid connection will allow additional horizontal and vertical movement as well as lateral and outward rotating of the panels. These movements act to absorb potential contact stresses rather than resisting them, thereby acting to protect the panels from cracking or failing.

3. Allowing Facing Elements to Take on the Curved or Snaking Alignments of the Structure. As shown in FIG. 18, another advantage of the free floating, non-rigid connection between the facing elements or panels and the structural block is the ability of the panel to rotate about the connection point to conform to curved or snaking wall alignments. It is desirable for the aesthetics of a structure, landscape wall, retaining wall, etc., to be able to create curved or snaking alignments. In general, in order to achieve relatively tight inside or outside radii in the horizontal alignment of the structure, the structural block dimensions must be limited to a size that will correspond to the desired radius of curvature. As such, the case may exist where the panel facing may span over two structural block units. In order to achieve a curved alignment, each structural block is rotated a few degrees from the normal straight alignment (counter-clockwise for outside curves and clockwise for inside curves). This rotation is allowed by having the block specially designed to have tapered sides (either one side or both). In order for the panels to span around and inside or outside curve, the point of contact at each end is forced to move its position. On an outside curve, the outside edges of the panel move out, away from the wall, with the panel rotating accordingly about the contact points. This would be impossible with a fixed, rigid, or permanently bonded connection. On an inside curve, the outside edges of the panel move in toward the structural block, while the middle of the panel moves out, away from the structural block, with the panel rotating accordingly about the contact points.

4. Corrects Height Differentials due to Manufacturing Tolerances Between the Block and the Veneer Panel at Each Elevation and Does not Allow Them to Accumulate. As our proposed veneer panels or facing elements are individually supported at each hanger/block level, a panel does not rely on the stack of panels below it for vertical support, which is the case with the G.P. Patent. As such, differences in the height of the panel relative to the height of the block do not have a negative “cumulative” effect when stacking with our invention. For example, in the manufacturing of concrete products, certain allowable dimensional tolerances exist. Currently, the National Concrete Masonry Guidelines allow for a tolerance on the height of a block to be within +/−3 mm (⅛″). As the facing panel and the block are being produced on different machinery and at different times, it is almost inevitable that differences will exist between the height of the SRW block and the veneer panel (facing panel). Applying the G.P. Patent, these minor height differences will accumulate over the height of the wall, worsening with each successive course. If, for example, a negative difference of 2 mm exists between the height of the blocks (+2 mm) and the height of the panels (0 mm), after only 5 courses of block, the cumulative effect will be that the wall will be 10 mm higher than the stack of facing panels in front. This will leave a 10 mm gap at the top of the wall. In contrast, with the integral connector and hanger system being proposed, our panel will be corrected at each level, resulting in the minor differences in height being taken up at each course, which actually promote a major concept of this system, which is allow free movement within the matrix of veneer panels for settlement, frost action, etc.

Additional Benefits of a Facing Element or Concrete Veneer Panel with an Integral Connector and Mold System.

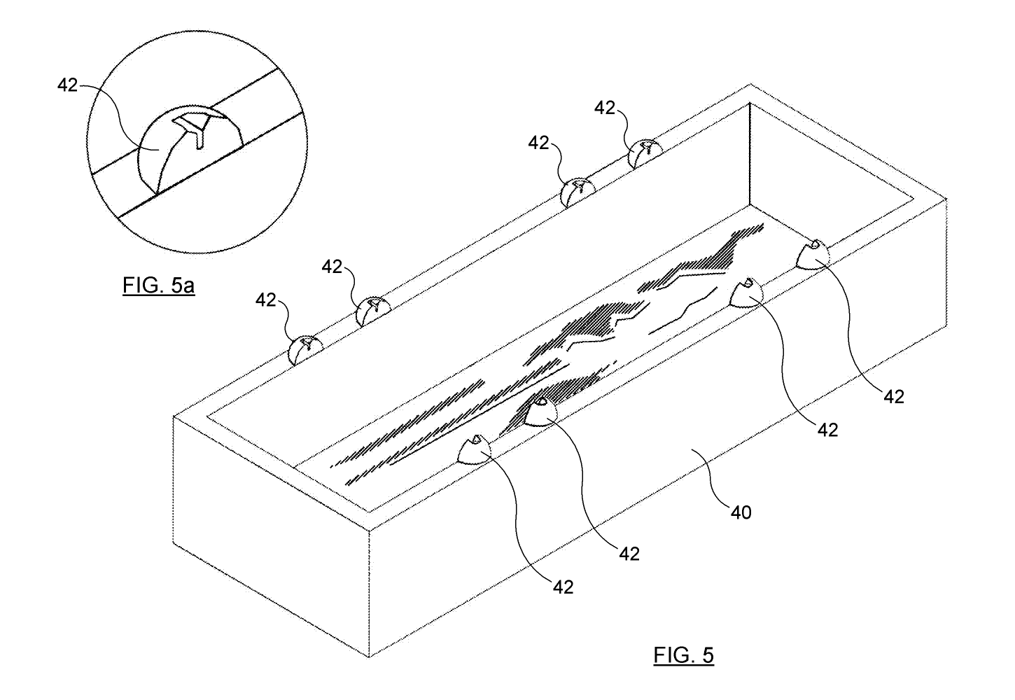

1. Ease of Manufacturing. The facing element or veneer panel is easily manufactured due to the fact that the mold and connector element have been designed to be fully compatible in all respects. As shown in FIGS. 5 to 8, the mold 40 has raised slots 42 to secure the connector element in place, automatically setting the connector at the correct depth into the concrete and correct location from top to bottom and side to side in the back of the panel. The raised slots keep the connector suspension bars 28′ out of the way of the concrete pour and maintain the position until the concrete cures.

2. Shipping of the Facing Element or Concrete Veneer Panel to the Job Site. One concern with wet casting stone or other materials is to ensure that the face is not scuffed or damaged during shipping. Typically, veneers would have to be packaged with protective layers (plastic or some other material) between the pieces to prevent abrasion between the rough textured faces. The proposed invention utilizes the integral engagement connectors in the back of the panel as an automatic buffer or bumper between adjacent panels when being shipped. The tough polymer engagement connectors provide an excellent wearing surface to prevent contact of concrete to concrete.

3. Ease of Installation. Currently, to secure facing elements or concrete veneers to a building or other structure, a lengthy, time consuming process is required where the building must first be sheathed in plywood or some other stiff membrane, which is then usually covered with a steel lathe sheet, on top of which a coat of mortar is used to secure the concrete veneer. This takes specialized skills, typically by a stone mason, a significant amount of time to mix and/or prepare the binding materials (mortar, adhesives). When installing them, the mortar must be allowed to set or cure prior to placing additional courses, which slows down installation significantly. Also, mortar and adhesives are vulnerable to unfavorable temperature, humidity, etc. when being used, which can affect long term performance. The proposed facing element or veneer panel with integral connector allows the user to simply hang the panel without the need for any mortar or adhesives. This does not require specialized skills and can be done very easily and quickly.

4. Less Limitation on Weight of the Facing Element or Veneer. Due to the fact that current concrete veneers are secured with mortars, the weight of the veneers must be limited. As a result, it is common to use light weight aggregates, which are more expensive, and the thickness (and therefore relief possible in the face of the veneer) is also limited. With the proposed invention, as a true mechanical connection is achieved, the weight of the veneer panel does not have to be limited. As such, normal aggregates can be used in the mix, which reduces cost of the veneer, and from an aesthetic point of view, substantial relief can be achieved, giving a bold and realistic look, as in the case of a natural dry stack stone retaining wall.

The invention disclosed creates a facing element that could be used in conjunction with the Risi/Matys system noted above. As well, it could be mounted on a hanger that is secured to the face of a standard building block, wood frame, etc.

So, as aforesaid, the object of the present invention is to provide a system for forming a facing element 10 or concrete veneer panel with compatibly designed connector elements set into the back of the panel. The connector elements 18,20 must be set into the concrete at a specific depth as well as at a specific horizontal and vertical position in the back of the concrete veneer panel.

The connectors 18,20 have been designed to be compatible with the mold, the concrete poured around the connectors, and the hanger that will support the panel on the face of the structure.

The mold 40 and connector 18,20 combination creates a facing element 10 or concrete veneer panel that can be supported on the face of a structure 12 such as a segmental retaining wall, where the connection is not rigidly fixed, allowing for minor movements in the structure, such as a segmental retaining wall, and negating the need for adhesive or mortar. This saves time, money, and provides a true mechanical connection of the facing, albeit a “free floating” connection.

The double “U” connectors 18,20 are preferably designed with the following distinct elements:

(i) The exposed portion of the connector, or the “U” shape, in the back of the concrete panel is to be placed over top of a mounting post or hanger that is secured to the structure, on which it would bear (see FIG. 15).

(ii) A symmetrical double “U” configuration which allows the facing element or panel to be used right side up or upside down, thereby changing the look of the veneer panel and varying the look of the veneers throughout the structure (see FIG. 1).

(iii) A symmetrical double “U” configuration where the upper of the “U”s is placed over top of the mounting post, which supports the panel, and the lower “U” acts as a bumper that rests against the face of the structure and keeps the facing element or panel face vertical (i.e. the bottom does not rotate in towards the structure) (see FIG. 15). In another preferred embodiment, a second lower hook can be placed on the hanger which secures the lower “bumper” from rotating outward and adds additional vertical support to the panel.

(iv) Between the upper and lower “U”, symmetrical, horizontal joining bars 28 join the two “U” elements or connectors 18,20 to maintain both as a single unit. While keeping the double “U”s together, these joining bars 28 also create a tension couple between them, allowing them to share a load being applied to one and not directly to the other. When the upper “U” is placed on the mounting post, the vertical load of the veneer panel is applied directly to it. Through tension, the joining bars 28 transfer some of the load placed on the upper “U” to the bottom “U”, providing double the structural resistance to the load.

(v) Outside of the upper and lower “U”, the joining bars 28 described above continue outward, creating symmetrical suspension bars 28′ that extend out from the edges of the top and bottom “U”. The suspension bars 28′ are in line with the interior joining bars described above, both being out of the way of the “U” opening to ensure the mounting post is not obstructed. These suspension bars 28′ extend past the top and bottom of the veneer panel and are set at a specific height on the sides of the “U”. The suspension bars 28′ are used to set the connectors into the raised receptacles formed into the sides of the wet cast mold. Immediately following the concrete pour, the connector is pushed into the wet concrete. The suspension bars 28′ are set into the raised receptacles, which stop the connector at the specified height and holds it in that position, partially suspended above the wet concrete. The receptacle in the wet cast mold is dimensioned to hold the suspension bars 28′ in place vertically, horizontally, and laterally. The relative and compatible positioning of the suspension bars 28′, the receptacle height, the top of the wet concrete surface, and the exposed height and width dimension of the “U” create an opening that is compatible with the hanger or male mounting post.

(vi) Each “U” shape is identical and is dimensioned to accept a hanger or mounting post with some room for lateral movement to adjust the position of the veneer panel side to side. This becomes necessary when an inside or outside curve is required.

(vii) The connectors are designed with anchorage legs 36 which are set into the wet concrete. The legs 36 are splayed at an angle to the vertical to avoid creating a weak vertical plane through the cross section of the concrete panel.

(viii) Due to the intricate shape of the connector, the most economical and efficient way of producing it currently is injection molding of a polymer. As most polymers will not bond with concrete, the shape of the anchorage legs 36 must minimize the amount of the polymer that exists within any single plane within the panel. By splaying the anchorage legs 36 apart, the weak zone created by the polymer within the concrete is spread out over a wider area and not concentrated in a single plane.

(ix) The feet on the end of the anchorage legs 36 are designed to provide vertical pullout capacity of the connector in the concrete as well as lateral pullout capacity. The vertical pullout capacity is generated along the length of the foot. The passive shear resistance of the cured concrete above the foot keeps it in place. In order for the connector to be pulled out of the concrete, all concrete above the connector foot must fail in shear. This produces a significant amount of pullout resistance. For lateral pullout resistance, that is, for the adjacent portion of the concrete panel to separate or pull away from the connector, the foot is designed with a passive bulb 38 on the end. This bulb 38 provides lateral resistance in the same way as the foot described above by generating passive resistance in the concrete adjacent to the bulb 38.

(x) All sides of the anchor or connector within the concrete are curved and/or rounded to prevent stress concentrations between the anchor and concrete.

(xi) During manufacturing the inserts are placed into the raised slots either manually or mechanically.

The flexible, wet cast mold 40 component is designed with the following distinct elements:

(i) Wherein the mold 40 is designed with a negative cavity creating the shape of the veneer panel, which may have a natural texture in the bottom and sides such as stone or wood, the mold 40 is closed on the bottom and sides, but open in the top to allow the placement of the wet concrete.

(ii) The mold 40 is preferably approximately rectangular or square in shape with raised slots 42 on the top surface of the mold sidewalls to accept suspension bars 28′ of the connector piece.

(iii) The raised slots 42 are in pairs on the top and bottom in order that the connector piece is supported equally on four extremities, ensuring it remains level while being set into the concrete. The raised slots 42 hold the suspension bars 28′ of the connector piece in place vertically, horizontally, and laterally, with very minor tolerances to ensure perfect positioning of the double “U” connector in the back of the panel.

(iv) As discussed above, the connector piece is designed with suspension bars 28′ that set into the raised slots of the mold sidewalls. The suspension bars 28′ extend perpendicularly from the body of the connector toward the top and bottom faces of the mold. The suspension bars 28′ extend a nominal distance past the edge of the mold sidewalls in order that they bear on the sidewalls. The connectors are suspended at a specific depth in the wet concrete temporarily until the concrete cures and hardens.

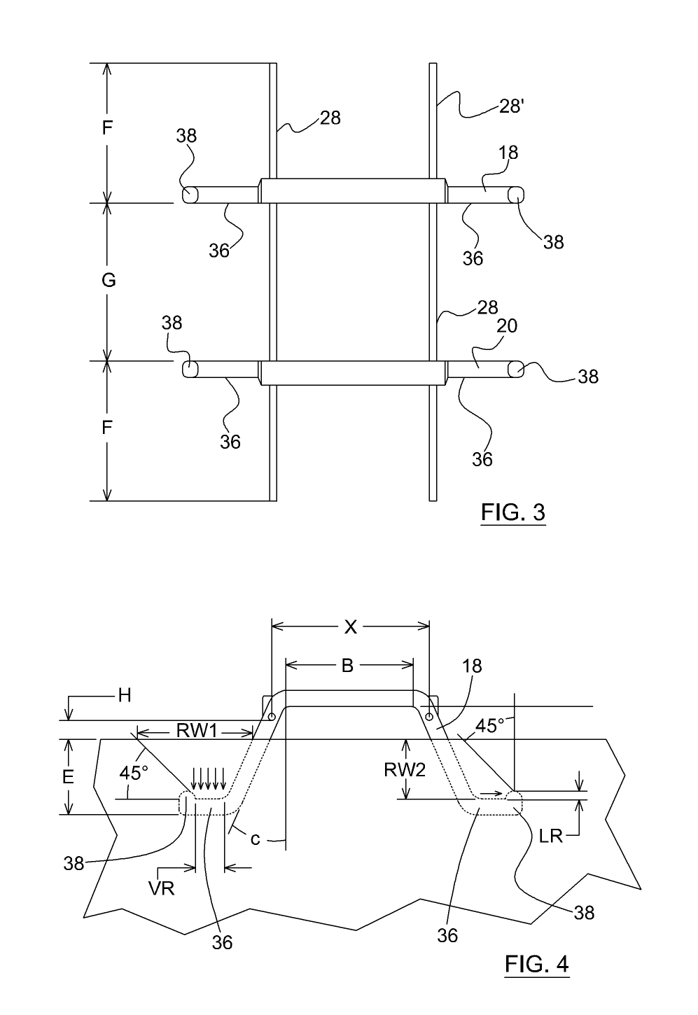

FIGS. 1 to 4 illustrate the connector element, composed of two U-shaped loops or connectors 18,20. FIGS. 1 and 2 are a perspective view and a side view of the female connector element known as the “double U”, that is placed into the back of the concrete veneer panel or facing element according to a first preferred embodiment of the invention. FIGS. 3 and 4 are the top view and the front view of the double U connector. The front view depicts the connectors partially immersed in concrete to show the final position in the back of the facing element or panel. The connectors have preferably a symmetrical double “U” configuration where the upper of the “U”s is placed over top of the mounting post, which supports the panel, and the lower “U” acts as a bumper that rests against the face of the structure and keeps the panel face vertical (i.e. the bottom does not rotate in towards the structure).

Each “U” shape is identical and is dimensioned to accept a hanger or mounting post with some room for lateral movement to adjust the position of the veneer panel side to side. Dimension B, (FIG. 4) indicates the interior width of the loop in the connector. Therefore, to provide room for lateral movement between the mounting post and the connector loop, B>outside diameter of the mounting post. This becomes necessary when an inside or outside curve is required. Between the upper and lower U-shaped loops, symmetrical, horizontal bars 28 (FIG. 1), join the two “U” elements to maintain both as a single unit. The joining bars 28 are of specific dimension G (FIG. 3) to ensure the double U's remain symmetrical in the facing element veneer panel from top to bottom in order that the panel can be inverted. While keeping the “double U”s together, these joining bars 28 also create a tension couple between them, allowing them to share a load being applied to one and not directly to the other. When the upper “U” is placed on the mounting post, the vertical load of the veneer panel or facing panel is applied directly to it. Through tension, the joining bars 28 transfer some of the load placed on the upper “U” to the bottom “U”, providing double the structural resistance to the load.

As mentioned, the symmetrical double “U” configuration allows the facing element or panel to be used right side up or upside down, thereby changing the look of the facing element or veneer panel and varying the look of the veneers throughout the structure.

Outside of the upper and lower “U”, the joining bars 28 described above continue outward, effectively creating symmetrical suspension bars 28′ (see FIG. 3), that extend out from the edges of the top and bottom “U” at a specific distance F. The distance F ensures that the suspension bars 28′ extend past the top and bottom of the concrete veneer panel and rest in the raised supports on the side of the mold. Dimensions are preferably G+2F>Z, (FIG. 3) the total panel height, with G being the distance between the inside edge or bearing edge of each loop and F being the distance from the top or outside edge (non-bearing edge) of each loop outward to the end of the suspension bars 28′.

The suspension bars 28′ are in line with the interior joining bars 28 described above, both being out of the way of the U opening or apertures 24,26 to ensure the mounting post is not obstructed. These suspension bars 28′ extend past the top and bottom of the veneer panel and are set at a specific height on the sides of the “U”. The suspension bars 28′ are used to set the connectors into the raised receptacles or mounting supports or slots 42 formed into the sides of the wet cast mold. Immediately following the concrete pour, the connector is pushed into the wet concrete. The suspension bars 28′ are set into the raised receptacles, which stop the connector at the specified height (H—FIG. 4) and hold it in that position, partially suspended about the wet concrete. The receptacle in the wet cast mold is dimensioned to hold snugly the suspension bars 28′ in place vertically, horizontally, and laterally. In the case where concrete is poured into the mold after the connectors are in place, the connectors should be restrained vertically to prevent floating or uplift from the buoyant wet concrete.

The relative and compatible positioning of the suspension bars 28′, the receptacle height, the top of the wet concrete surface, and the exposed height and width dimension of the “U” create an opening that is compatible with the hanger or male mounting post.

The connector piece is designed with anchorage legs which are set into the wet concrete 4, FIG. 3. The legs are splayed at an angle to the vertical to avoid creating a weak vertical plane through the cross section of the concrete panel.

Due to the intricate shape of the connector, the most economical and efficient way of producing it currently is injection molding of a polymer. As most polymers will not bond with concrete, the shape of the anchorage legs must minimize the amount of the polymer that exists within any single plane within the panel. By splaying the anchorage legs apart, the weak zone created by the polymer within the concrete is spread out over a wider area and not concentrated in a single plane. This is one of the challenges in combining these materials and a major concept of the invention. In short, to provide pullout resistance within the concrete, while acknowledging that given the typical materials that may be used to form the double loop (plastics), a natural bond between the plastic and concrete will not occur. As a natural bond will not exist between the materials, a weak plane is created along their interface. As noted above, the legs are splayed at an angle C (FIG. 4) from the vertical in order to minimize the cross sectional area through any one vertical plan (top to bottom of the panel) of the plastic. Furthermore, it is critical that the connectors and the concrete must be compatible materials. Specifically, properties including water absorption, permeability, modulus of elasticity, coefficient of thermal expansion, chemical resistance, dimensional stability, and flexural modulus must be kept within specific allowable limits to ensure internal stresses due to changes in moisture, temperatures, as well as conditions within the concrete are accommodated.

The passive shear resistance of the cured concrete above the foot keeps it in place. In order for the connector to be pulled out of the concrete, all concrete above the connector foot must fail in shear. This produces a significant amount of pullout resistance. For pullout resistance in the outward direction, the feet 5 (FIG. 4) extend out from the bottom of the anchorage legs a distance VR (FIG. 4). As concrete typically shears at approximately a 1H:1V line, the foot engages a resisting wedge of the cured concrete above it that extends out to a maximum width at the surface of RW1 (FIG. 4). For pullout resistance laterally, a resistance bulb 6, is placed on the end of each foot. The bulb, raised a distance of LR (FIG. 4) provides lateral resistance. Given the same shearing angle of 1H:1V, the bulb is able to generate lateral shearing resistance from a wedge of cured concrete adjacent to it (inside of it) to a maximum height of RW2 (FIG. 4). This lateral resistance addresses the case where a tension crack may occur in the panel somewhere along the anchorage foot, but the adjacent panel is still held in place due to the lateral or side to side anchorage effect of the bulb.

FIG. 4 illustrates that all sides of the anchor within the concrete are curved and/or rounded to prevent stress concentrations between the anchor and concrete. This is another challenge, and significant concept, of marrying these two materials.

According to the present invention, there is also provided a method of fabricating a facing element for at least partially covering a structure, the method comprising the steps of:
a) providing a mold comprising:
   a bottom wall, a front wall, a rear wall and opposite sidewalls forming a closed bottom enclosure with an open top; and
   at least one pair of opposite facing mounting slots, respectively positioned on a top portion of each of the opposite sidewalls;
b) providing at least one connector piece comprising:
   a pair of first and second rigid engagement connectors; and
   at least one joining bar joining the first and second engagement connectors, said at least one joining bar sized to extend and set into the at least one pair of opposite facing mounting slots;
c) inserting the at least one connector piece into the mounting slots of the mold;
d) pouring a casting substance into the mold up to a level wherein each of the first and second engagement connectors forms first and second apertures between said connectors and a top surface of the poured casting substance, said first and second apertures being coaxially located;
e) curing the casting substance to form the facing element; and
f) removing the casted facing element from the mold.

FIG. 5 shows a typical single panel mold 40 box, preferably manufactured from a flexible material such as polyurethane. The mold 40 is designed with a negative cavity creating the shape of the veneer panel, which may have a natural texture, in the bottom and sides, such as stone or wood or any other material. FIG. 7 shows a cross section through the mold 40 which depicts the textured bottom surface 50 of the cavity. The mold 40 is closed on the bottom and sides, but open in the top to allow the placement of the wet concrete. The mold box would likely be made with multiple or “gang” cavities for better economy as the panels would share sidewalls. The raised supports on either side are used to suspend the double U connector in the correct position in three axes (vertically, horizontally, and laterally).

The mold 40 and connectors are designed to be compatible in that the sides of the mold have specially designed “raised slots” 42 to accept the suspension bars 28′ that are integral to the connector piece. The raised slots 42 position the connectors 18,20 to the correct depth in the wet concrete as well as the correct position both horizontally and vertically along the back of the panel.

The mold is approximately rectangular or square in shape with raised mounting slots 42, on the top and the bottom of the mold sidewalls to accept suspension bars 28′ of the connector piece. The raised slots are in pairs on the top and bottom in order that the connector piece is supported equally on four corners, ensuring it remains level while being set into the concrete. The raised slots hold the suspension bars 28′ of the connectors in place vertically, horizontally, and laterally, with very minor tolerances to ensure perfect positioning of the double “U” connector in the back of the panel.

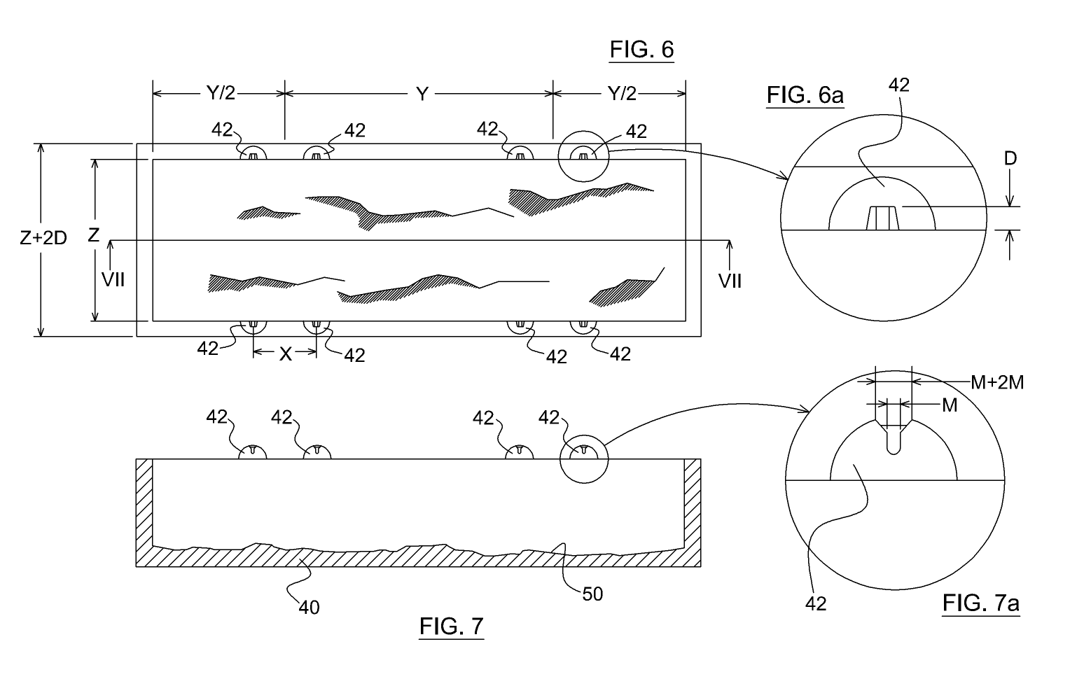

As discussed above, the connector piece is designed with suspension bars 28′ that set into the raised slots of the mold sidewalls. The suspension bars 28′ extend perpendicularly from the body of the connector toward the top and bottom of the mold. The suspension bars 28′ extend a nominal distance past the edge of the mold sidewalls in order that they bear on the sidewalls and the connector is suspended at a specific depth in the wet concrete temporarily until the concrete cures and hardens. FIGS. 6a and 7a show exploded close-up views of an example of the preferred embodiment of the raised mounting slots 42. The width of the slot in the bottom of the channel M (see FIG. 7), would be approximately the width of the suspension bars 28′ to ensure a tight fit and prevent the connector element from moving around once it was placed in the wet concrete. To guide the suspension bars 28′ into place, the top of the raised mounting slot is widened to a nominal maximum of 2M. The double U connector elements can be placed manually or this can be automated as the double U connectors are designed to nest into each other into a stack and be loaded into a cartridge, which would allow a machine to dispense them.

The bottom of the slot 42 (see FIG. 5), is set at a specific distance from the top of the mold 40 equal to height H (see FIG. 4) to ensure that the appropriate amount of space is left between the inside of the connector loop and the top surface of the concrete to allow the hanger or mounting post to fit into this space snugly.

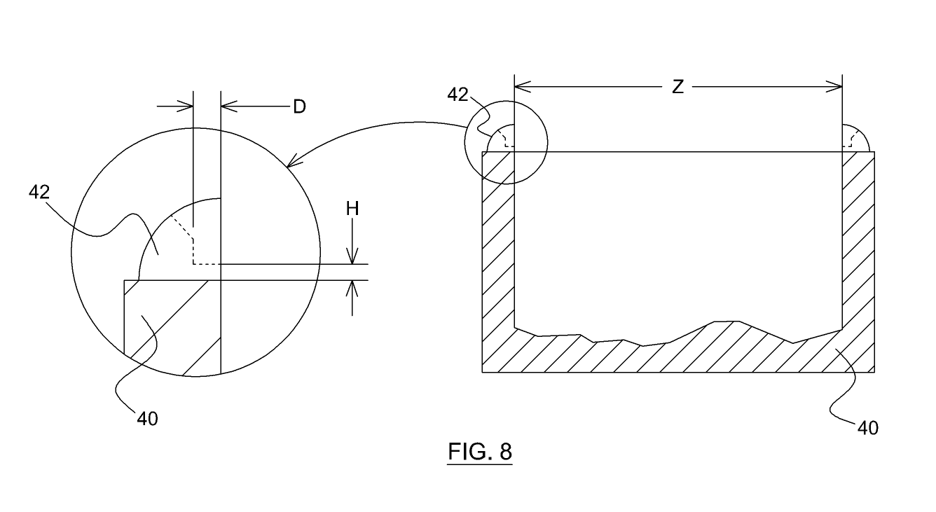

FIG. 8 is an end view of the mold with an exploded close-up (8a) of the raised supports in section. The rear of the top of the slot is also angled back 10 (as shown in FIG. 8a) to guide the suspension bars 28′ into place from top to bottom. The suspension bars 28′ extend over the sides of the facing element by an amount equal to D (FIG. 8a), where 2D+Z would equal the total length of the connector element as it extended a distance D over the top and bottom edges of the panel of height Z.

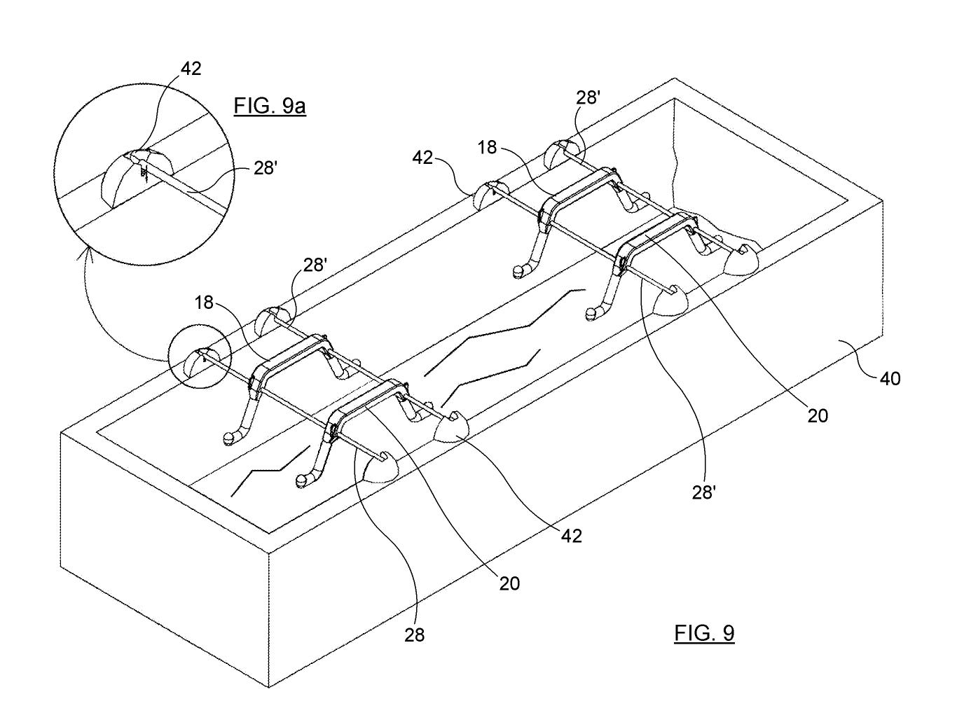

FIG. 9 is a perspective view of a single panel mold 40 with the connectors 18,20 set into the raised mounting slots 42 to position them at the specific depth required for anchorage, centered from top to bottom in the facing element, and side to side to match with the location of the male mounting post or “hanger” secured to the structure 12 being faced. FIG. 9a is an exploded close-up of the raised support elements and mounting slots 42.

FIG. 10 shows the double U connectors 18,20 suspended above the mold 40. The lateral placement of the two connector elements is at a distance Y (FIG. 10) from center to center and Y/2 from each edge. The distance Y would correspond to the center to center separation of the mounting posts secured to the wall or other structure that will accept the panels.

FIG. 11 shows the cross sectional view of the double U connectors 18,20 suspended in the concrete within the mold cavity. The anchorage legs 36 are embedded a depth E, determined by the amount of pullout resistance required, based on the weight of the facing element and outward load the connectors must carry.

FIG. 12 is a side sectional view of the mold 40 with the connectors 18,20 set into place as described above. FIG. 12a is an exploded close-up of a suspension bar 28′ resting into the slot 42 of the raised support.

FIG. 13 is a perspective view of the mold 40 filled with concrete with the double U connectors 18,20 suspended in the raised mounting slots 42. The dark hatched area indicates the portion of the anchoring legs 36 that are embedded in the casting substance. The connector elements 18,20 are thus partially submerged until the concrete can cure and they are able to hold position independently.

FIG. 14 shows a representation of a typical facing element 10 after being extracted from the mold 40 following curing of the concrete. The face 52 is a replica of the desired texture. The connectors 18,20 are secured into the cured concrete.

FIG. 15 shows a facing element 10 being mounted onto a segmental retaining wall block 60 with the system described in Risi/Matys Patent Application CA 2,547,415 “Combination of a Structural Block and Facing Element attached Thereto”. Multiple facing elements 10 would be mounted onto the entire face of the wall. A corresponding “hanger” element is placed into a slot on the face of the block which fits snugly into the connectors 18 in the back of the facing element.

FIG. 16 shows the facing element 10 being mounted on a wood frame building 64. In this case, the hanger element 66 is formed into a strip that is screwed or lagged into the sheathing on the outside of the building or inside for aesthetic facing purposes.

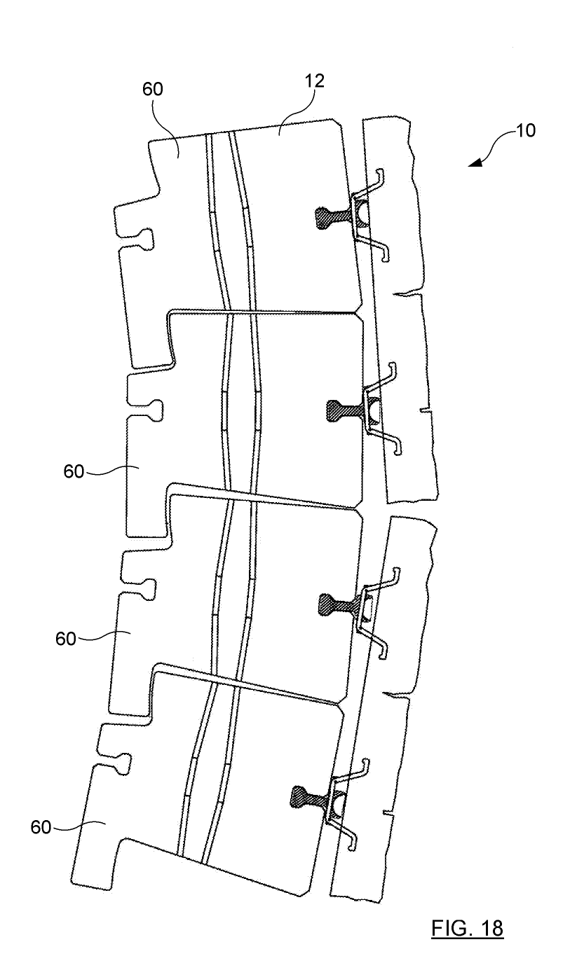

FIG. 17 shows facing elements 10 being mounted on the segmental retaining wall blocks 60 as in FIG. 15, but shown with multiple blocks 60 in a row in straight alignment.

In contrast, FIG. 18 shows the facing elements 10 being mounted on the segmental retaining wall blocks 60 in a curved arrangement. A significant advantage of the free floating, non-rigid connection between the facing panels 10 and the structural block 60 is the ability of the panel to rotate about the connection point to conform to curved or snaking wall alignments. It is desirable for the aesthetics of a structure, landscape wall, retaining wall, etc., to be able to create curved or snaking alignments. In general, in order to achieve relatively tight inside or outside radii in the horizontal alignment of the structure, the structural block 60 dimensions must be limited to a size that will correspond to the desired radius of curvature. As such, the case may exist where the panel facing may span over two structural block units as in the straight wall configuration, in FIG. 17. In order to achieve a curved alignment, each structural block 60 is rotated a few degrees from the normal straight alignment (counter-clockwise for outside curves and clockwise for inside curves). This rotation is allowed by having the block specially designed to have tapered sides (either one side or both). In order for the facing elements to span around an inside or outside curve, the point of contact at each end is forced to move its position (FIG. 18). On an outside curve, the outside edges of the facing element move out, away from the wall, with the facing element rotating accordingly about the contact points. This would be impossible with a fixed, rigid, or permanently bonded connection. On an inside curve, the outside edges of the facing element 10 move in toward the structural block 60, while the middle of the facing element 10 moves out, away from the structural block 60, with the facing element 10 rotating accordingly about the contact points.

Although the present invention has been explained hereinabove by way of preferred embodiments thereof, it should be pointed out that any modifications to these preferred embodiments within the scope of the appended claims is not deemed to alter or change the nature and scope of the present invention.

1. A facing element for at least partially covering a structure, said facing element comprising:
a top portion and a bottom portion;
at least one pair of first and second rigid engagement connectors made of plastic and affixed to a rear surface of the facing element, each of the first and second engagement connectors forming first and second apertures between said connectors and the rear surface of the facing element, said first and second apertures being coaxially located; and
at least one joining rod joining a top portion of the first and second engagement connectors, said top portion being offset from the facing element,
wherein the top portion of the facing element is hung to said structure by means of the first engagement connector, and a contact of the bottom portion of the facing element with respect to the structure is offset by the second engagement connector.

2. The facing element according to claim 1, comprising two parallel joining rods joining the first and second engagement connectors.

3. The facing element according to claim 1, wherein the first and second engagement connectors are substantially U-shaped.

4. The facing element according to claim 1, wherein the first and second engagement connectors are affixed to the facing element by molding the facing element around the first and second engagement connectors.

5. The facing element according to claim 1, wherein the facing element is made of a pre-cast concrete.

6. The facing element according to claim 1, wherein the second engagement connector is positioned to fit on a secondary securing hanger extending from the structure when the top portion of the facing element is hung to the structure.

7. The facing element according to claim 1, wherein the at least one joining rod joining the first and second engagement connectors extends beyond two opposite sides of the rear surface of the facing element.

8. The facing element according to claim 1, wherein each of the first and second engagement connectors comprises a pair of anchorage legs set in the facing element and said legs are splayed at an angle with respect to the rear surface of the facing element.

9. The facing element according to claim 8, wherein each anchorage leg comprises a bulb at an extremity of said leg.

10. A method of fabricating a facing element for at least partially covering a structure, the method comprising the steps of:
a) providing a mold comprising:
a bottom wall, a front wall, a rear wall and opposite sidewalls forming a closed bottom enclosure with an open top; and
at least one pair of opposite facing mounting slots, respectively positioned on a top portion of each of the opposite sidewalls;
b) providing at least one connector piece comprising:
a pair of first and second rigid engagement connectors made of plastic; and
at least one joining rod joining a top portion of the first and second engagement connectors, said at least one joining rod sized to extend and set into the at least one pair of opposite facing mounting slots;
c) inserting the at least one connector piece into the mounting slots of the mold through the at least one joining rod;
d) pouring a casting substance into the mold up to a level wherein each of the first and second engagement connectors forms first and second apertures between said connectors and a top surface of the poured casting substance, said first and second apertures being coaxially located, said at least one joining rod and the top portion of the first and second engagement connectors being offset from the poured casting substance;
e) curing the casting substance to form the facing element;
f) removing the casted facing element from the mold.

11. The method according to claim 10, wherein the at least one connector piece comprises two parallel joining rods joining the first and second engagement connectors.

12. The method according to claim 10, wherein the first and second engagement connectors are substantially U-shaped.

13. The method according to claim 10, wherein the casting substance is a pre-cast concrete.

14. The method according to claim 10, wherein each of the first and second engagement connectors comprises a pair of anchorage legs set in the facing element and said legs are splayed at an angle with respect to the rear surface of the casted facing element.

15. The method according to claim 14, wherein each anchorage leg comprises a bulb at an extremity of said leg.
